(19) United States
(12) Patent Application Publication
(10) Pub. No.: US 2014/0350899 A1
(43) Pub. Date: Nov. 27, 2014

(54) NUMERICAL METHOD TO SIMULATE COMPRESSIBLE VORTEX-DOMINATED FLOWS

(71) Applicant: Ming Lu, Tianjin (CN)

(72) Inventor: Ming Lu, Tianjin (CN)

(21) Appl. No.: 13/978,704

(22) PCT Filed: Nov. 30, 2011
(86) PCT No.: PCT/CN2011/083188

§ 371 Date: Jul. 30, 2014

(51) Int. Cl. G06F 17/50

(52) U.S. Cl. CPC G06F 17/5009
USPC 703/2

(57) ABSTRACT

The present invention relates a numerical method to simulate compressible vortex-dominated flows. Specifically, it is a numerical method compensating the voracity diffusion caused by adding the artificial diffusion. This method used in this invention is called the Vorticity Diffusion Compensation (VDC). The VDC term is equivalent in magnitude and opposite in direction to the artificial diffusion.

### TECHNICAL FIELD OF THE INVENTION

The present invention relates a numerical method in computation fluid dynamics. Particularly, it is a numerical method and this method can be implemented using the computer codes and the code can be run on computers to simulate the compressible vortex-dominated flows.

### BACKGROUND OF THE INVENTION

Computational fluid dynamics (CFD), containing the fluid dynamics, applied mathematics, computer science, is a highly-applied science. The numerical simulation to fluid dynamic problems, due to its low cost and visualization properties, occupies an important position in exploration to the mechanism of fluid flows and in design of industrial products. A biggest challenge for CFD is to improve simulation accuracy, reduce error, to loyally descript the characteristics of fluid flows.

One of the important factors to affect the accuracy of CFD is the numerical diffusion in the numerical solutions when numerical methods are used to solve the fluid flow governing equations, the Euler or Navier-Stokes equations. For examples, the spatial discretization schemes, such as the central or upwind difference, the temporal discretization schemes, such as the explicit or implicit time integration, the turbulence models, such as the two-equation or LES model, and the orthogonality of computing grids, all could produce the numerical diffusion. Additionally, to improve the numerical solutions convergence, some artificial diffusion is often added in numerical simulations by deducing computing accuracy to some extent. For examples, the capture of the discontinuity interfaces, such as shocks, is achieved by appropriately adding some artificial diffusion in avoiding the numerical oscillation around the large pressure gradient in the numerical solutions with high-order accuracy. The numerical diffusion can be considered as a kind of energy loss in the flow field, which could make the computational results be not very accurate. The advanced numerical methods should minimize the numerical diffusion under premise of achieving the convergent numerical solutions.

The most significant effect of the numerical diffusion to the numerical simulation results is on the capture to the discontinuity interfaces. As mentioned above, it physically makes sense to add some artificial diffusion to capture the strong continuity interfaces, such as shocks, since across which the velocity, density and pressure all are discontinuous and there exist the energy losing in the form of entropy increasing. However, over large artificial diffusions could make the shock interfaces smeared, which reduces the prediction accuracy of the shock intensity and position. Another type discontinuity in flow field is the contact discontinuity. Compared to the strong discontinuity, it is a weak one and its interface is the slip-line, across which there is no mass transfer and the pressure and velocity in normal direction are continuous while the density and tangent velocity are discontinuous. There exist the interfaces with typical contact discontinuity in kinds of vortex-dominated flows. For examples, the flow field around a delta wing with large aspect ratio flying with a large angle of attack is vortex-dominated. Besides, those of helicopter rotors, turbine blades have the same situations. The numerical simulation to the contact discontinuity is more difficult, since very little amount of numerical diffusion could make its smeared to a point damaging the fidelity to the simulation. This is why developing the numerical methods to simulate the vortex-dominated flows is a big challenge for CFD workers.

The governing equations for the compressible viscous flows, the Navier-Stokes equations, include the continuity equation and momentum equations, which are

$$\begin{matrix}\frac{\partial ρ}{\partial t} + ∇ \cdot ( ρ \vec{V} ) = 0 ; & ( 1 ) \\ \frac{\partial \vec{V}}{\partial t} + ( \vec{V} \cdot ∇ ) \vec{V} = - \frac{1}{ρ} ∇ p + \frac{1}{3} \frac{μ}{ρ} ∇ ( ∇ \cdot \vec{V} ) + \frac{μ}{ρ} {∇}^{2} \vec{V} + \vec{B} , & ( 2 )\end{matrix}$$

where the velocity vector \vec{V}=ui+vj+wk including, three components u, v, w in the direction index i, j, k in the Cartesian coordinate system; ρ, p, t, μ respectively represents the density, pressure, time and dynamic viscosity. And more, the operator ∇ presents

$$∇ = \frac{\partial }{\partial x} i + \frac{\partial }{\partial y} j + \frac{\partial }{\partial z} k ;$$

the symbol · does the inner product. In the momentum equation (2),

$$\frac{μ}{ρ} ∇ ( ∇ \cdot \vec{V} )$$

represents the shear stress dynamic viscous term due to compression;

$$\frac{μ}{ρ} {∇}^{2} \vec{V}$$

does the normal stress dynamic viscous term, where ∇² is the Laplacian operator

$$( {∇}^{2} = \frac{{\partial }^{2}}{\partial {x}^{2}} + \frac{{\partial }^{2}}{\partial {y}^{2}} + \frac{{\partial }^{2}}{\partial {z}^{2}} ) ,$$

\vec{B} does the body force. For a vortex-dominated flow field, \vec{ω}, the voracity, is introduced. In the Cartesian coordinate system, \vec{ω}=ωₓi+ω_{y}j+ω_{z}k (ωₓ, ω_{y}, ω_{z} is the three component of \vec{ω} indirection index i, j, k) and formally,

$$\overleftarrow{ω} = ∇ \times \vec{V} = \vert \begin{matrix}i & j & k \\ \frac{\partial }{\partial x} & \frac{\partial }{\partial y} & \frac{\partial }{\partial z} \\ u & v & w\end{matrix} \vert = ( \frac{\partial w}{\partial y} - \frac{\partial v}{\partial z} ) i + ( \frac{\partial u}{\partial z} - \frac{\partial w}{\partial x} ) j + ( \frac{\partial v}{\partial x} - \frac{\partial u}{\partial y} ) k , \qquad ( 3 )$$

where the operator × presents the cross-product.

If the ∇ operation is applied on the equation (2), with considering the equation (1) and the definition of vorticity, the vorticity equation for compressible viscous flows can be derived as

$$\frac{\partial \vec{ω}}{\partial t} + ( \vec{V} \cdot ∇ ) \vec{ω} = ( \vec{ω} \cdot ∇ ) \vec{V} - \vec{ω} ( ∇ \cdot \vec{V} ) + v {∇}^{2} ω + \frac{∇ ρ \times ∇ p}{{ρ}^{2}} + ∇ \times ( \frac{1}{3} v ∇ ( ∇ \cdot \vec{V} ) ) + ∇ \times \vec{B} . \qquad ( 4 )$$

where ν is the kinemics viscosity with definition ν=μ/ρ. The left hand of above equation is the rate of change of vorticity; the first term of the right is the generation of vorticity due to three-dimensional deformation; the second term is the change of vorticity due to compression; The third and fifth are the diffusion of vorticity duo to viscosity; the forth is the generation of vorticity due to the interaction of pressure and density gradients; the sixth is the one due to body forces. in two-dimensional case, (\vec{ω}·∇)\vec{V}=0; for the barotropic flows

$$\frac{∇ ρ \times ∇ p}{{ρ}^{2}} = 0 ;$$

for the incompressible flows ν∇²ω=0 and ∇×(⅓ν∇(∇·\vec{V}))=0.

The vorticity diffusion term ν∇²ω in right hand side of equation (4), which is caused by the fluid viscosity, has the most significant effect to the vorticity field. The added artificial diffusion in form of viscosity causes the extra vorticity diffusion besides that caused by the real fluid viscosity. The viscosity effect, as well as the artificial viscosity, has the elliptic characteristics, which means that the viscosity effect is spatially isotropic.

A method to improve the simulation accuracy of vortex-dominated flows is that solving the flow governing equations by using very fine computing grid, which needs to cost more computing time. Moreover, the computing error could accumulate with the number of computing grid cells increasing. Another method is that intensifying the variable describing vortex flow movement, the vorticity, by artificially adding physics models when solving the flow governing equations. For examples, adding the point vortex model could artificially increase the vorticity. Locally solving the vorticity equation could reduce the vorticity losing in its transportation. However, the usage of those methods is quite limited, since the point vortex model is only for some simple flow situations where the position of vortex is previously known. Solving the vorticity equation is more complicated than doing the Euler and Navier-Stokes equations themselves except for the two-dimensional cases. The last method is that using the spatial discretization schemes with minimum numerical diffusion, such as ENO, WENO spatial discretization schemes on the convection term when solving the equations (1-2). However, those schemes still bring over large diffusions in numerical solutions, which reduce the simulation accuracy of contact discontinuity and make the discontinuous interfaces smeared.

The governing equations for compressible flows are a set of partial differential equations (PDE), including the continuity, momentum, and energy equation. It is called the Euler equations for invicid flows; while the Navier-Stokes ones for viscous flows. In engineering applications, the numerical solutions of the governing equations can be achieved by using finite volume method (FVM), which needs the governing equations being a conservation form and to perform the spatial and temporal discretization on the computing grid generated in advance. Each computing cell is considered as a control volume, where the time-dependent change of the conservation variables is achieved by the summation of the fluxes through the surface of the control volume during a time-step. The fluxes mentioned above mean the conservation variables flux, convection flux, viscous flux and artificial diffusion flux. There are several different spatial discretization schemes, such as JST, VanLeer, CUSP, AUSM, Roe, etc., can be used to calculate those fluxes. The viscous term usually is discretized using the central difference scheme, since its elliptic characteristics. As mentioned before, any spatial discretization scheme need some artificial diffusion, which can be directly added in JST, CUSP, Roe, or indirectly done in VanLeer, AUSM. The artificial diffusion, as an error source, reduces the simulation accuracy of the vortex structure while it stabilizes the numerical solutions. For the vortex-dominated flows, over-added artificial diffusion makes the vorticity in flow field over diffusive.

To more accurately simulate compressible vortex-dominated flows, it is necessary to modify the mechanism to capture the contact discontinuity in flow field. A new way to do is to compensate the vorticity diffusion induced by the artificial diffusion based on the equation (4) which describes the vorticity changing in flow field, at the same time, to do the high-order spatial discretization to the compensated vorticity diffusion. This way forms an original numerical simulation method to the compressible vortex-dominated flows in the present invention.

### SUMMARY OF THE INVENTION

The present invention relates a numerical method to simulate compressible vortex-dominated flows. Specifically, it is a numerical method about compensating the vorticity diffusion caused by adding the artificial diffusion to counteract the numerical diffusions in any spatial discretizing schemes. The term added is called the Vorticity Diffusion Compensation (VDC) term. This method used in this invention is called VDC method.

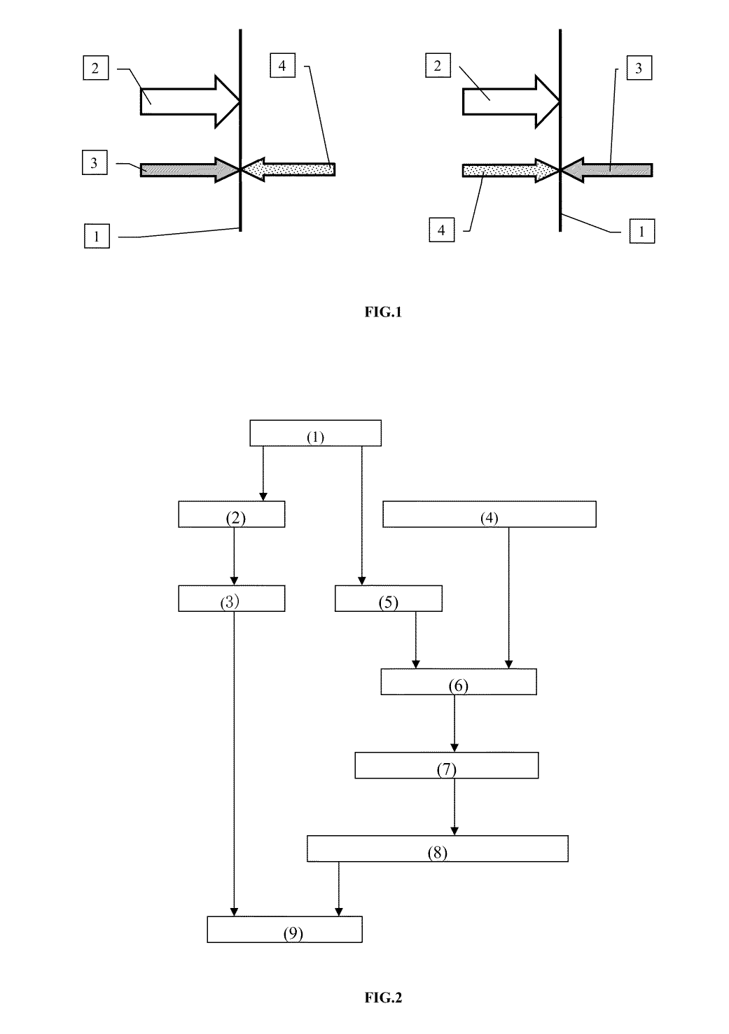

Since the vorticity diffusion has the most significant fluent to the vorticity field, part of it produced by the artificial diffusion must be minimized. A principle to make the vorticity diffusion in vortex-dominated flows minimum is to keep the direction of vorticity diffusion along that of the maximum vorticity magnitude gradient. Adding the artificial diffusion makes the two directions diverged, which produces the over large vorticity diffusion. In this invention, a way to solve this problem is adding a VDC term at the computing cell interfaces to compensate this over large vorticity diffusion. This term should be equivalent in magnitude and opposite in direction to the artificial diffusion. The principle of the VDC method is shown in FIG. 1, where at any interface of two computing cells (1), there are the convection flux including the viscous flux (2), the added artificial diffusion flux (3), and the vorticity diffusion compensation flux (4) with an equivalent magnitude and opposite direction to the added artificial diffusion flux (3), which can counteract some numerical diffusion. The VDC method has the following properties:
1. The VDC term should be added after performing the artificial diffusion to the convection flux when any spatial discretization scheme is used, which doesn't affect the stability of the original numerical schemes.
2. The VDC term is used to counteract the numerical diffusion irrelevant to the real fluid viscosity.
3. The VDC term is cancelled in case its direction is identical to the maximum gradient direction of the vorticity magnitude.

From dimensional analysis, the VDC term \vec{F}_{ω} is the product of the density with the mass unit VDC, \vec{f}_{ω} which is defined as

\vec{f}_{ω}=\vec{n}_{ω}×(ν_{ω}(∇²\vec{ω})R_{c}²), (5)

where the symbol × presents the cross-product and \vec{n}_{ω} presents the maximum gradient direction of vorticity magnitude; ν_{ω} does the numerical viscosity, as a scalar variable with the same dimension as the fluid kinemics viscosity, which is a coefficient for vortex movement compensation; R_{c} does the characteristic radii of the vorticity compensation. For the maximum gradient direction of vorticity magnitude

$${\vec{n}}_{ω} = \frac{∇ φ}{\vert ∇ φ \vert} , \qquad ( 6 )$$

where φ the vorticity magnitude; ∇φ is the gradient of the vorticity magnitude; |∇φ| is the magnitude of ∇φ, which tells the direction of the maximum vorticity change. They are defined as

$$\begin{matrix}φ = \vert \vec{ω} \vert = \sqrt{{ω}_{x}^{2} + {ω}_{y}^{2} + {ω}_{z}^{2}} , & ( 7 ) \\ ∇ φ = \frac{\partial φ}{\partial x} i + \frac{\partial φ}{\partial y} j + \frac{\partial φ}{\partial z} k , & ( 8 ) \\ \vert ∇ φ \vert = \sqrt{{( \frac{\partial φ}{\partial x} )}^{2} + {( \frac{\partial φ}{\partial y} )}^{2} + {( \frac{\partial φ}{\partial z} )}^{2}} . & ( 9 )\end{matrix}$$

### Decision of the Numerical Viscosity ν_{ω}

The implicitly appeared artificial diffusion term in the momentum equation (2) should have the dimension of Laplacian operator to velocity (∇²\vec{V}) because it behaviors as the viscous diffusion. Do the rotation operation (∇×) to the artificial diffusion term, one can find

∇×(∇²\vec{V})=∇²\vec{ω}+(∇(∇²))×\vec{V}. (10)

Without accounting for the third order derivative term in right-hand side of the equation (10), the rotation of the Laplacian operator to velocity becomes the Laplacian operator to vorticity, which means that the artificial diffusion in equation (2) implicitly is equivalent to the vorticity diffusion term in the equation (4), so that any added vorticity in form of Laplacian operator can compensate some artificial diffusion in the equation (2), which can improve the numerical simulation precision.

Generally, the artificial diffusion term needs to be scaled by local velocity. For example, in the publicly known JST method, a spectral radius, as the maximum eigenvalue of the convection vector, is used as the scale coefficient. The spectral radii Λ

Λ=|V|+c, (11)

where c is the speed of sound; V is the contravariant velocity and V≡\vec{V}·\vec{n}=unₓ+vn_{y}+wn_{z}; \vec{n}=└nₓ, n_{y}, n_{z}┘ is the unit normal direction vector of computing grid interfaces. Taking the rotation operation to Λ, and getting a term with the dimension of vorticity (see formula (3)), then using it to scale the vorticity diffusion term ∇²\vec{ω}. The numerical viscosity ν_{ω} is induced by the numerical viscosity and should have the dimension of the fluid kinematic viscosity. A numerical viscosity vector is defined as

$${\vec{V}}_{ω} = \frac{{\vec{R}}_{ω}^{2}}{\vert \vec{ω} \vert} , \qquad ( 12 )$$

where \vec{R}_{ω}=R_{ω}^{I}i+R_{ω}^{J}j+R_{ω}^{K}k, the radii vector of the compensated vorticity, is defined as

\vec{R}_{ω}=R_{c}\vec{k}. (13)

In above definition and equation (5), R_{c}, the characteristic radii of the vorticity compensation, for two and three dimension is respectively

R_{c}=½Ω^{1/2} and R_{c}=½Ω^{1/3}, (14)

where Ω is the cell area of computing grid for two-dimensional cases; while it is the volume for three-dimensional cases.

Explanation of the Characteristic Radii of the Vorticity Compensation:

The compensated vorticity has an equivalent circulation for itself. And its averaged effect is measured by the characteristic radii of the vorticity compensation, like in definition (14), which is half grid cell scale.

To increase the amount of vorticity compensation across a viscous layer and modify that for grid deformation, the vorticity direction vector \vec{k}=k^{I}i+k^{J}j+k^{K} k in definition (13) needs to an anisotropic treatment, so that

$$\begin{matrix}{k}^{I} = 1 + max [ \vert \frac{{ω}_{y}}{{ω}_{x}} \vert , \vert \frac{{ω}_{z}}{{ω}_{x}} \vert ] , & ( 15 ) \\ {k}^{J} = 1 + max [ \vert \frac{{ω}_{x}}{{ω}_{y}} \vert , \vert \frac{{ω}_{z}}{{ω}_{y}} \vert ] , & ( 16 ) \\ {k}^{K} = 1 + max [ \vert \frac{{ω}_{x}}{{ω}_{z}} \vert , \vert \frac{{ω}_{y}}{{ω}_{z}} \vert ] . & ( 17 )\end{matrix}$$

Finally, the numerical viscosity ν_{ω}, as a contravariant variable, is obtained by

$${v}_{ω} ≡ {\vec{v}}_{ω} \cdot \vec{n} = \frac{1}{\vert \vec{ω} \vert} [ {( {R}_{ω}^{I} )}^{2} {n}_{x} + {( {R}_{ω}^{J} )}^{2} {n}_{y} + {( {R}_{ω}^{K} )}^{2} {n}_{z} ] . \qquad ( 18 )$$

The above derivation procedure is summarized in a flow chart shown in the FIG. 2, which also is followed in the computation of numerical simulation.

The VDC term \vec{F}_{ω} in the equation (5) can be rewritten in a three-dimensional component form in Cartesian coordinator system as

$${\vec{F}}_{ω} = \frac{ρ {v}_{ω} {R}_{c}^{2}}{\vert ∇ φ \vert} [ \begin{matrix}0 \\ 0 \\ \frac{\partial φ}{\partial z} \frac{{\partial }^{2} {ω}_{z}}{\partial {x}^{2}} - \frac{\partial φ}{\partial x} \frac{{\partial }^{2} {ω}_{z}}{\partial {z}^{2}} \\ \frac{\partial φ}{\partial x} \frac{{\partial }^{2} {ω}_{z}}{\partial {y}^{2}} - \frac{\partial φ}{\partial y} \frac{{\partial }^{2} {ω}_{z}}{\partial {x}^{2}} \\ v ( \frac{\partial φ}{\partial z} \frac{{\partial }^{2} {ω}_{z}}{\partial {x}^{2}} - \frac{\partial φ}{\partial x} \frac{{\partial }^{2} {ω}_{z}}{\partial {z}^{2}} ) + w ( \frac{\partial φ}{\partial x} \frac{{\partial }^{2} {ω}_{z}}{\partial {y}^{2}} - \frac{\partial φ}{\partial y} \frac{{\partial }^{2} {ω}_{z}}{\partial {x}^{2}} )\end{matrix} ] {n}_{x} + \frac{ρ {v}_{ω} {R}_{c}^{2}}{\vert ∇ φ \vert} [ \begin{matrix}0 \\ \frac{\partial φ}{\partial y} \frac{{\partial }^{2} {ω}_{z}}{\partial {z}^{2}} - \frac{\partial φ}{\partial z} \frac{{\partial }^{2} {ω}_{z}}{\partial {y}^{2}} \\ 0 \\ \frac{\partial φ}{\partial x} \frac{{\partial }^{2} {ω}_{z}}{\partial {y}^{2}} - \frac{\partial φ}{\partial y} \frac{{\partial }^{2} {ω}_{z}}{\partial {x}^{2}} \\ u ( \frac{\partial φ}{\partial y} \frac{{\partial }^{2} {ω}_{z}}{\partial {z}^{2}} - \frac{\partial φ}{\partial z} \frac{{\partial }^{2} {ω}_{z}}{\partial {y}^{2}} ) + w ( \frac{\partial φ}{\partial x} \frac{{\partial }^{2} {ω}_{z}}{\partial {y}^{2}} - \frac{\partial φ}{\partial y} \frac{{\partial }^{2} {ω}_{z}}{\partial {x}^{2}} )\end{matrix} ] {n}_{y} + \frac{ρ {v}_{ω} {R}_{c}^{2}}{\vert ∇ φ \vert} [ \begin{matrix}0 \\ \frac{\partial φ}{\partial y} \frac{{\partial }^{2} {ω}_{z}}{\partial {z}^{2}} - \frac{\partial φ}{\partial z} \frac{{\partial }^{2} {ω}_{z}}{\partial {y}^{2}} \\ \frac{\partial φ}{\partial z} \frac{{\partial }^{2} {ω}_{z}}{\partial {x}^{2}} - \frac{\partial φ}{\partial x} \frac{{\partial }^{2} {ω}_{z}}{\partial {z}^{2}} \\ 0 \\ u ( \frac{\partial φ}{\partial y} \frac{{\partial }^{2} {ω}_{z}}{\partial {z}^{2}} - \frac{\partial φ}{\partial z} \frac{{\partial }^{2} {ω}_{z}}{\partial {y}^{2}} ) + v ( \frac{\partial φ}{\partial z} \frac{{\partial }^{2} {ω}_{z}}{\partial {x}^{2}} - \frac{\partial φ}{\partial x} \frac{{\partial }^{2} {ω}_{z}}{\partial {z}^{2}} )\end{matrix} ] {n}_{z} , \qquad ( 19 )$$

where the first row of elements in the components is for the continuity equation, the second to fourth one are for the momentum equation, the fifth one for the energy equation.

The present invention uses the so-called Vorticity Diffusion Compensation (VDC) numerical method to simulate compressible vortex-dominated flows. Specifically, it is a numerical method to precisely capture the vortex structure in flow field by counteracting the numerical diffusion by adding the vorticity compensation. This method can be easily called as a subroutine in user's previous computer language codes to run in computers. It is highly practical and low cost.

### THE BRIEF DESCRIPTION OF FIGURES

The FIG. 1 is the principle of the Vorticity Diffusion Compensation (VDC), where (1) is any interface of two computing cells; (2) is the convective flux including the viscous flux; (3) is the added artificial diffusion flux; (4) is the voracity diffusion compensation (VDC) flux.

The FIG. 2 is the procedure to calculate the Vorticity Diffusion Compensation (VDC) term.

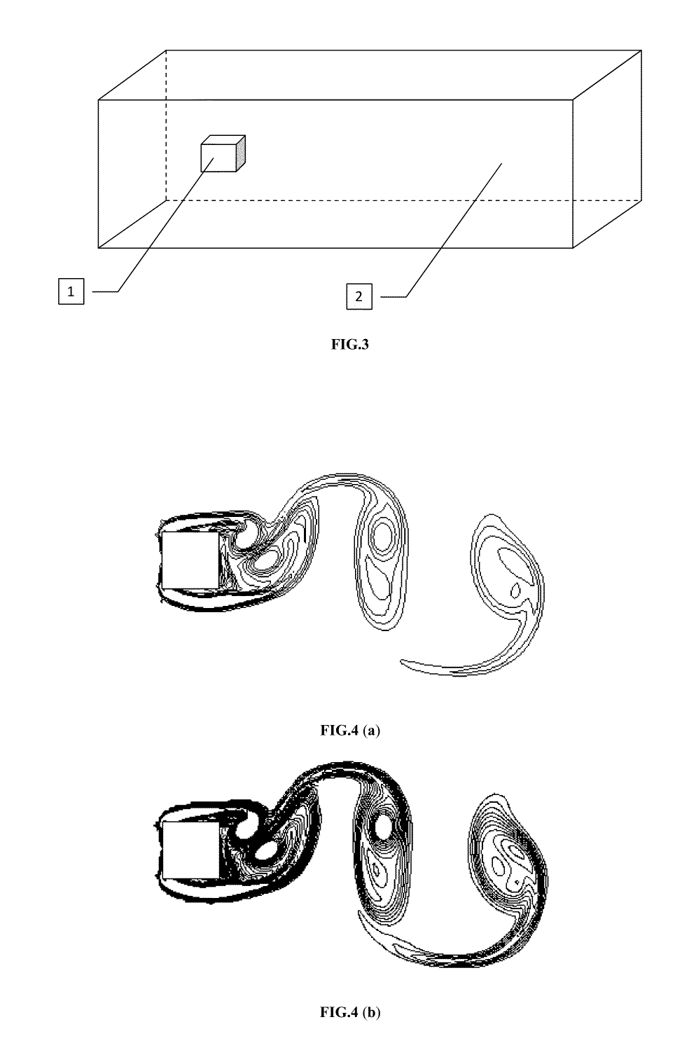

The FIG. 3 is the computational domain about a flow field passing a cube, where (1) is the cube and (2) is the computational domain.

The FIG. 4 is the validation of the results by the invented method.

### DETAILED DESCRIPTION OF THE PREFERRED EMBODIMENT

A preferred embodiment according to the present invention is illustrated following. It is related to the Vorticity Diffusion Compensation (VDC), a numerical method to precisely simulate compressible vortex-dominated flows by adding the VDC term to counteract the numerical diffusion in current spatial discretization schemes.

There is a flow field behind a cube with a length of side, D, like in the FIG. 3. The computational domain (2) is up to 10 times of D behind the cube (1) and 5 times D in other boundaries. The computing grid is the structured hexahedron grid with totally 200×150×150 cells. Each cell is a control volume Ω with 6 surface elements ∂Ω.

Firstly, write the governing equations for the three-dimensional compressible invicid flows, the Euler equations, in the conservation form,

$$\frac{\partial }{\partial t} {\int }_{Ω} \vec{W} d Ω + {\int }_{\partial Ω} ( {\vec{F}}_{c} - {\vec{F}}_{ω} ) d S = {\int }_{Ω} Q d Ω , \qquad ( 20 )$$

where the conservation variable \vec{W} and the convection vector \vec{F}_{c} are respectively

$$\vec{W} = [ \begin{matrix}ρ \\ ρ u \\ ρ v \\ ρ w \\ ρ E\end{matrix} ] , {\vec{F}}_{c} = [ \begin{matrix}ρ V \\ ρ uV + {n}_{x} p \\ ρ vV + {n}_{y} p \\ ρ wV + {n}_{z} p \\ ρ HV\end{matrix} ] , \qquad ( 21 )$$

where the contravariant velocity V is the dot-product of \vec{V} and the unit normal vector \vec{n}=nₓi+n_{y}j+n_{z}k

V=\vec{V}·\vec{n}=nₓu+n_{y}v+n_{z}w; (22)

the total energy E and the total enthalpy H is respectively

$$\begin{matrix}E = \frac{1}{γ - 1} \frac{p}{ρ} + \frac{{‖ \vec{V} ‖}_{2}}{2} ; & ( 23 ) \\ H = E + \frac{p}{ρ} . & ( 24 )\end{matrix}$$

Since there no body force, then the source term \vec{Q}=0. The VDC term, \vec{F}_{ω}, has been given in the formula (19).

The numerical scheme used to solve the equations (20) is the JST method, for which the central difference to the conservation variables \vec{W} is used and the artificial dissipation is added at the same time to avoid the odd-even oscillation in the numerical solutions. The equations (20) are discretized as

$$\frac{\partial \vec{W}}{\partial t} = - \frac{1}{Ω} {\sum }_{m = 1}^{6} [ {\vec{F}}_{c} ( {\vec{W}}_{m} ) Δ {S}_{m} - {\vec{D}}_{m} - {\vec{F}}_{ω} Δ {S}_{m} ] , \qquad ( 25 )$$

where the subscribe m means any interface of computing cells. For example, for the i-direction in the three-dimensional case, at the interface i+½ (between i and i+1),

\vec{W}_{i+1/2}=½(\vec{W}ᵢ+\vec{W}ᵢ₊₁) (26)

The convection flux at i+½ is \vec{F}_{c}(\vec{W}_{i±1/2})ΔS_{i+1/2} and the artificial dissipation here

\vec{D}_{i+1/2}=∇_{i+1/2}[ε_{i+1/2}²(\vec{W}ᵢ₊₁−\vec{W}ᵢ)−ε_{i+1/2}⁴(\vec{W}ᵢ₊₂−3\vec{W}ᵢ₊₁+3\vec{W}ᵢ−\vec{W}ᵢ₋₁)], (27)

where the coefficient

ε_{i+1/2}²=k₂max(νᵢ₊₁,νᵢ);

ε_{i+1/2}⁴=max[0,(k₄−ε_{i+1/2}²)], (28)

where k₂=0.5, k₄= 1/96. A pressure-based sensor

$${v}_{i} = \vert \frac{{p}_{i + 1} - 2 {p}_{i} + {p}_{i - 1}}{{p}_{i + 1} + 2 {p}_{i} + {p}_{i - 1}} \vert$$

is used to switch off the fourth-order differences at shocks. The artificial dissipation is scaled by ∇_{i+1/2}, the spectral radii of the convection flux Jacobian, in all coordinator direction.

An auxiliary computing grid staggering to the original one is needed to calculate the first-and second order derivative terms in \vec{F}_{ω} at the interface m according to the Green formula. The center of the cells of the auxiliary grid is that of the cell interface of the original computing grid. The procedure to calculate the VDC term \vec{F}_{ω} at any cell interfaces is described in the FIG. 2, where
(1) Calculate \vec{ω} in the auxiliary computing grid.
(2) Calculate φ according to the equation (7).
(3) Calculate ∇φ according to the equation (8).
(4) Calculate R_{c} according to the equation (14).
(5) Calculate \vec{k}=k^{I}i+k^{J}j+k^{K}k according to the equation (15-17).
(6) Calculate \vec{R}_{ω}=R_{ω}^{I}i+R_{ω}^{J}j+R_{ω}^{K}k according to the equation (13).
(7) Calculate \vec{ν}_{ω} according to the equation (12).
(8) Calculate ν_{ω} according to the equation (18).
(9) Calculate the VDC term \vec{F}_{ω} according to the equation (19).

For the temporal discretization, a hybrid Multi-stage Runge-Kutta explicit time marching scheme is used. Meanwhile, a local time-step and the residual smooth is used to accelerate convergence. In detailed,

$${\vec{W}}_{m}^{( 0 )} = {\vec{W}}_{i}^{n} \\ {\vec{W}}_{i}^{( 0 )} = {\vec{W}}_{i}^{( 0 )} - {α}_{1} \frac{Δ t}{Ω} {( {\vec{R}}_{c}^{( 0 )} - {\vec{R}}_{d}^{( 0 )} )}_{i} \\ {\vec{W}}_{i}^{( 2 )} = {\vec{W}}_{i}^{( 0 )} - {α}_{2} \frac{Δ t}{Ω} {( {\vec{R}}_{c}^{( 1 )} - {\vec{R}}_{d}^{( 0 )} )}_{i} \\ {\vec{W}}_{i}^{( 3 )} = {\vec{W}}_{i}^{( 0 )} - {α}_{3} \frac{Δ t}{Ω} {( {\vec{R}}_{c}^{( 2 )} - {\vec{R}}_{d}^{( 2 , 0 )} )}_{i} \\ {\vec{W}}_{i}^{( 4 )} = {\vec{W}}_{i}^{( 0 )} - {α}_{4} \frac{Δ t}{Ω} {( {\vec{R}}_{c}^{( 3 )} - {\vec{R}}_{d}^{( 2 , 0 )} )}_{i} \\ {\vec{W}}_{i}^{( 5 )} = {\vec{W}}_{i}^{( 0 )} - {α}_{5} \frac{Δ t}{Ω} {( {\vec{R}}_{c}^{( 4 )} - {\vec{R}}_{d}^{( 4 , 2 )} )}_{i} , \qquad ( 29 )$$

where the superscripts are to mention the time step and integration step; \vec{R}_{c} is the right hand side of equation (25), but

\vec{R}_{d}^{(2,0)}=β₃\vec{R}_{d}⁽²⁾+(1−β₃)\vec{R}_{d}⁽⁰⁾; (30)

\vec{R}_{d}^{(4,2)}=β₅\vec{R}_{d}⁽⁴⁾+(1−β₅)\vec{R}_{d}^{(2,0)}. (31)

In each time step, all coefficients α, β and σ are given in the following table

| | |
|---|---|
| Central σ = 3.6 | Upwind σ = 2.0 |

| step | α | β | α | β |
|---|---|---|---|---|
| 1 | 0.2500 | 1.00 | 0.2742 | 1.00 |
| 2 | 0.1667 | 0.00 | 0.2067 | 0.00 |
| 3 | 0.3750 | 0.56 | 0.5020 | 0.56 |
| 4 | 0.5000 | 0.00 | 0.5142 | 0.00 |
| 5 | 1.000 | 0.44 | 1.000 | 0.44 |

The far-field boundary conditions are publicly known and in the solid wall the non-slip boundary condition is used

\vec{V}=0. (32)

When fluid passes a non-streamlined body in a given rang of Reynolds number (Re), since the adverse pressure gradient exists in the boundary layer of the fluid on the body, the fluid starts to separate with the time developing. A lot of experimental and theoretical studies had shown that when Re is from 50 to 500, the vortices are continuously and periodically shed down from each side of the body along the incoming flow direction and rotation direction of the paired vortices is alternate. Two stable, regularly spaced rows of vortices with laminar core are formed in the wake behind the body. This fluid motion pattern is called the Karman vortex street.

For the numerical simulation of the Karman vortex, it needs to capture the vortex structure in the wake flows, which is belong to the weak discontinuity in the vortex-dominated flows.

In this preferred embodiment, the incoming flow velocity is 0.3 Mach. The FIG. 4 gives the validation of the results based on the invented numerical method. It shows an Iso-vorticity contour map on a central section along the incoming flow direction in the wake near behind the cube. The FIG. 4 (a) is a reference results from the turbulence LES simulation, which is publicly known. The FIG. 4 (b) is the results by the invented method, where only the Euler equations plus the VDC term and the non-slip wall boundary condition is used and there is no accounting for the turbulence and viscosity of the incoming flow. However, the results show that there are more refined Iso-vorticity contour lines in the FIG. 4 (b) than that in the FIG. 4 (a), which means that the invented method can give the results with strong voracity level for the vortex-dominated flow field.

What is claimed is:

1. A computer implemented numerical method to simulate compressible vortex-dominated flows, said numerical method includes adding a Vorticity Diffusion Compensation (VDC) term \vec{F}_{ω} at the computing grid interfaces when spatially discretizing the fluid flow governing equations.

2. The method of claim 1, wherein said Vorticity Diffusion Compensation term is obtained by the fluid density ρ being multiplied by an unit vorticity diffusion compensation vector \vec{f}_{ω}, which has the expression as
\vec{f}_{ω}=\vec{n}_{ω}×(ν_{ω}(∇²\vec{ω})R_{c}²),
where,
\vec{n}_{ω} being a maximum gradient direction of vorticity magnitude;
ν_{ω} being a contravariant numerical viscosity, as a scalar variable, with the same dimension as the fluid kinemics viscosity;
R_{c} being a characteristic radii of the vorticity compensation;
\vec{ω}, being a vorticity, \vec{ω}=ωₓi+ω_{y}j+ω_{z}k in the Cartesian coordinate system, where ωₓ, ω_{y}, ω_{z}, is the three components of \vec{ω} in direction index i, j, k;
symbol × being the cross-product operation;
symbol ∇² being the Laplacian operator.

3. The method of claim 2, wherein said maximum gradient direction of vorticity magnitude \vec{n}_{ω} is obtained by
$${\vec{n}}_{ω} = \frac{∇ φ}{\vert ∇ φ \vert} ,$$
where
φ being a magnitude of said vorticity, φ=|\vec{ω}|=\sqrt{ωₓ²+ω_{y}²+ω_{z}²};
∇φ being a gradient of φ,
$$∇ φ = \frac{\partial φ}{\partial x} i + \frac{\partial φ}{\partial y} j + \frac{\partial φ}{\partial z} k ;$$

|∇φ| being a gradient of ∇φ,
$$\vert ∇ φ \vert = \sqrt{{( \frac{\partial φ}{\partial x} )}^{2} + {( \frac{\partial φ}{\partial y} )}^{2} + {( \frac{\partial φ}{\partial z} )}^{2}} .$$

4. The method of claim 2, wherein said characteristic radii of the vorticity compensation R_{c} is defined as for two-dimensional cases as
R_{c}=½Ω^{1/2};
For three-dimensional cases as
R_{c}=½Ω^{1/3},
where Ω being the computing cell area for two-dimensional cases and the volume for three-dimensional cases.

5. The method of claim 2, wherein said contravariant numerical viscosity ν_{ω} is defined as
ν_{ω}≡\vec{ω}_{ω}·\vec{n},
where \vec{ν}_{ω} being a numerical viscosity vector; \vec{n}=└nₓ, n_{y}, n_{z}┘ being an unit normal direction vector of computing grid interfaces; symbol · being the dot-product.

6. The method of claim 5, wherein said numerical viscosity vector \vec{ν}_{ω} is defined as
$${\vec{v}}_{ω} = \frac{{\vec{R}}_{ω}^{2}}{\vert \vec{ω} \vert} ,$$
where \vec{R}_{ω} being a radii vector of the compensated vorticity.

7. The method of claim 6, wherein said radii vector of the compensated vorticity \vec{R}_{ω} is defined as
\vec{R}_{ω}=R_{c}\vec{k},
where \vec{k}=k^{I}i+k^{J}j+k^{K}k being the vorticity direction vector and
$$\begin{matrix}{k}^{I} = 1 + max [ \vert \frac{{ω}_{y}}{{ω}_{x}} \vert , \vert \frac{{ω}_{z}}{{ω}_{x}} \vert ] , \\ {k}^{J} = 1 + max [ \vert \frac{{ω}_{x}}{{ω}_{y}} \vert , \vert \frac{{ω}_{z}}{{ω}_{y}} \vert ] , \\ {k}^{K} = 1 + max [ \vert \frac{{ω}_{x}}{{ω}_{z}} \vert , \vert \frac{{ω}_{y}}{{ω}_{z}} \vert ] .\end{matrix}$$

8. The method of claim 1, wherein said Voracity Diffusion Compensation (VDC) term \vec{F}_{ω} can be rewritten in a three-dimensional component form in Cartesian coordinator system as
$${\vec{F}}_{ω} = \frac{ρ {v}_{ω} {R}_{c}^{2}}{\vert ∇ φ \vert} [ \begin{matrix}0 \\ 0 \\ \frac{\partial φ}{\partial z} \frac{{\partial }^{2} {ω}_{z}}{\partial {x}^{2}} - \frac{\partial φ}{\partial x} \frac{{\partial }^{2} {ω}_{z}}{\partial {z}^{2}} \\ \frac{\partial φ}{\partial x} \frac{{\partial }^{2} {ω}_{z}}{\partial {y}^{2}} - \frac{\partial φ}{\partial y} \frac{{\partial }^{2} {ω}_{z}}{\partial {x}^{2}} \\ v ( \frac{\partial φ}{\partial z} \frac{{\partial }^{2} {ω}_{z}}{\partial {x}^{2}} - \frac{\partial φ}{\partial x} \frac{{\partial }^{2} {ω}_{z}}{\partial {z}^{2}} ) + w ( \frac{\partial φ}{\partial x} \frac{{\partial }^{2} {ω}_{z}}{\partial {y}^{2}} - \frac{\partial φ}{\partial y} \frac{{\partial }^{2} {ω}_{z}}{\partial {x}^{2}} )\end{matrix} ] {n}_{x} + \frac{ρ {v}_{ω} {R}_{c}^{2}}{\vert ∇ φ \vert} [ \begin{matrix}0 \\ \frac{\partial φ}{\partial y} \frac{{\partial }^{2} {ω}_{z}}{\partial {z}^{2}} - \frac{\partial φ}{\partial z} \frac{{\partial }^{2} {ω}_{z}}{\partial {y}^{2}} \\ 0 \\ \frac{\partial φ}{\partial x} \frac{{\partial }^{2} {ω}_{z}}{\partial {y}^{2}} - \frac{\partial φ}{\partial y} \frac{{\partial }^{2} {ω}_{z}}{\partial {x}^{2}} \\ u ( \frac{\partial φ}{\partial y} \frac{{\partial }^{2} {ω}_{z}}{\partial {z}^{2}} - \frac{\partial φ}{\partial z} \frac{{\partial }^{2} {ω}_{z}}{\partial {y}^{2}} ) + w ( \frac{\partial φ}{\partial x} \frac{{\partial }^{2} {ω}_{z}}{\partial {y}^{2}} - \frac{\partial φ}{\partial y} \frac{{\partial }^{2} {ω}_{z}}{\partial {x}^{2}} )\end{matrix} ] {n}_{y} + \frac{ρ {v}_{ω} {R}_{c}^{2}}{\vert ∇ φ \vert} [ \begin{matrix}0 \\ \frac{\partial φ}{\partial y} \frac{{\partial }^{2} {ω}_{z}}{\partial {z}^{2}} - \frac{\partial φ}{\partial z} \frac{{\partial }^{2} {ω}_{z}}{\partial {y}^{2}} \\ \frac{\partial φ}{\partial z} \frac{{\partial }^{2} {ω}_{z}}{\partial {x}^{2}} - \frac{\partial φ}{\partial x} \frac{{\partial }^{2} {ω}_{z}}{\partial {z}^{2}} \\ 0 \\ u ( \frac{\partial φ}{\partial y} \frac{{\partial }^{2} {ω}_{z}}{\partial {z}^{2}} - \frac{\partial φ}{\partial z} \frac{{\partial }^{2} {ω}_{z}}{\partial {y}^{2}} ) + v ( \frac{\partial φ}{\partial z} \frac{{\partial }^{2} {ω}_{z}}{\partial {x}^{2}} - \frac{\partial φ}{\partial x} \frac{{\partial }^{2} {ω}_{z}}{\partial {z}^{2}} )\end{matrix} ] {n}_{z}$$
where u, v, w are the three components of velocity in the Cartesian coordinate system.
